(19) United States
(12) Patent Application Publication
(10) Pub. No.: US 2013/0055255 A1
(43) Pub. Date: Feb. 28, 2013

(54) SYSTEMS AND METHODS FOR COMMON APPLICATION PLATFORMS UTILIZING SHARED SERVICES

(71) Applicants: Bill Wagner, Malvern, PA (US); Frederick F. Hermanson, Annville, PA (US); Louis Battista, Malvern, PA (US); Aaron Campbell, Feasterville, PA (US)

(72) Inventors: Bill Wagner, Malvern, PA (US); Frederick F. Hermanson, Annville, PA (US); Louis Battista, Malvern, PA (US); Aaron Campbell, Feasterville, PA (US)

(73) Assignee: Rovi Technologies Corporation, Santa Clara, CA (US)

(21) Appl. No.: 13/223,053

(22) Filed: Aug. 31, 2011

(51) Int. Cl. G06F 9/455

(52) U.S. Cl. 718/1

(57) ABSTRACT

Systems and methods are disclosed that include a common application platform including a set of shared services that can be utilized by applications executing on top the application platform. One embodiment of the invention includes a user device including a processor configured by an operating system, where the processor is further configured by an application platform including a natively implemented virtual. machine configured to execute non-natively implemented applications; a services container, including at least one natively implemented service configured for utilization by an application executing within the virtual machine, wherein the at least one natively implemented service is a shared service that can be utilized by a plurality of different applications; and at least one handler configured to handle communication via at least one socket between an application executing within the virtual machine and the at least one natively implemented service in the services container.

### FIELD OF THE INVENTION

The present invention generally relates to consumer electronics devices and more specifically to common application platforms for consumer electronics devices implemented using a natively implemented services container.

### BACKGROUND OF THE INVENTION

Consumer electronic (CE) devices are typically proprietary platforms. CE devices are generally resource limited user devices with limited memory and processing power. CE devices can be contrasted with devices endowed with sufficient resources for a range of functions that can be resource intensive, such as a personal. computer. A CE device, such as a mobile phone or Internet television, typically requires a significant investment to create and maintain. Additionally, a CE device may include security features, such as proprietary access information for CE device updates and other services from CE device creators or managers.

CE devices can utilize applications to make a device more useful. An application is software that performs a specific task for a user. This is in contrast to software, which integrates a device's capabilities, such as an operating system. Many applications on CE devices are natively implemented. The term “natively implemented” is typically used to describe an application that is specifically designed to run on a device platform, such as a device's operating system and machine firmware. A natively implemented application typically needs to be ported, or adapted, for each different device on which it is implemented.

In contrast to a natively implemented application, a web application has all or some parts of the application software downloaded from the Internet each time it is run. A web application is generally reliant on a web browser to render the application executable and can usually be accessed from all web capable CE devices or CE devices with web browsers.

Many web applications run within a virtual machine (VM). For example, Flash applications can execute within a Flash VM utilizing ActionScript and HTML applications utilizing JavaScript, a scripting or programming language that can be used to render dynamic websites, can execute within a VM within a web browser's rendering engine. A web browser is an example of a VM, or a software implementation of a programmable machine, where the software implementation is constrained within another processor at a higher level of symbolic abstraction. A web browser VM is capable of accessing information resources over the Internet in HyperText Markup Language (HTML), which can be rendered by a web browser's rendering engine to be transformed from markup languages to an interactive document. A Flash VM is another VM, which can run within a web browser, that is capable of playing back Small Web Format (SWF) files, which is a file format specified by Adobe Systems Incorporated of San Jose, Calif. for multimedia, vector graphics, and ActionScripts. A number of CE platforms now exist that attempt to use a flash virtual machine (VM) and/or a rendering engine to enable web applications to run on CE devices, such as disclosed in U.S. patent application Ser. No. 12/986,957 entitled “Real Time Flash Based User Interface for Media Playback Device”, hereby incorporated by reference in its entirety.

Web applications, such as those running in a virtual machine, can operate using a web service. A web service manages communication interoperating between different applications running on a variety of platforms. An example of a web service is a service provider, such as a server, and a web service requester, such as a client, communicating over the Internet.

A number of web applications using web services communicate over the Internet via sockets. A socket is an endpoint of a bidirectional data flow that allows for programs to communicate. Socket communication can be contrasted with traditional. polling communication over the Internet. Polling is synchronized communication where a client and server must communicate with each other sequentially to coordinate data being sent and received in one direction by either the client or server. In contrast, socket communication is in full duplex mode, or is an open asynchronous channel that is capable of communication in either direction and at the same time. Socket communication is supported in HTML 5, or the fifth revision of the Hyper Text Markup Language (HTML) used for structuring and presenting content over the Internet.

### SUMMARY OF THE INVENTION

Systems and methods in accordance with embodiments of the invention include natively implemented services in a services container on a user device that can be utilized and shared among non-natively implemented applications executing within a virtual machine and natively implemented applications. One embodiment of the invention includes a user device including a processor configured by an operating system, where the processor is further configured by an application platform including a natively implemented virtual machine configured to execute non-natively implemented applications; a services container, including at least one natively implemented service configured for utilization by an application executing within the virtual machine, wherein the at least one natively implemented service is a shared service that can be utilized by a plurality of different applications; and at least one handler configured to handle communication via at least one socket between an application executing within the virtual machine and the at least one natively implemented service in the services container.

In a further embodiment, the handler is configured to handle communication by passing the communication from an application to a service associated with a service request type specified in the communication.

In another embodiment, the handler is configured to determine the service associated with a service request using a handler registry and the handler registry comprises a look up table associating service request types with services.

In a still further embodiment, the handler registry is updated when the services container is loaded into dynamic memory in the user device.

In a still another embodiment, the processor is part of the firmware of the user device and the firmware also comprises read only memory in which the operating system and the application platform are stored.

In a yet further embodiment, the application platform further comprises a porting layer.

In yet another embodiment, the device further includes a natively implemented application to further configure the processor and the natively implemented application is configured to communicate with at least one natively implemented service via at least one socket.

In a further embodiment again, the virtual machine is a web browser with a browser rendering engine.

In another embodiment again, the non-natively implemented application is a web application.

In another additional. embodiment, the communication is a string in Extensible Markup Language (XML).

In a still yet further embodiment, the at least one natively implemented service performs a service that is at least one of: content playback, cloud transport, entertainment store transport, 3^{rd} party application launch, application updating, application loading, content data listings, tuner functions, recorder functions, Digital. Living Network Alliance (DLNA) compatible functionality, and Universal Plug and Play (UPnP) functionality.

In a still yet further embodiment of the method of executing an application that utilizes at least one service in a services container, where the services container is part of a common application platform implemented on a user device of the invention includes sending at least one communication from a non-natively implemented application executing within a virtual machine to a service within a service container via a socket interface, where the virtual machine is natively implemented and forms part of a common application platform implemented on a user device; identifying a service request type within the at least one communication using a handler in the services container; determining a service associated with the service request type using the handler; and passing the at least one communication to the associated service in the services container using the handler.

In a still yet another embodiment, determining the associated service comprises querying the service request type in a look up table on the user device that associates service request types with services in the services container.

In a still further embodiment again, the natively implemented virtual machine is part of a web browser rendering engine.

In still another embodiment again, the non-natively implemented application is a web application.

In still further additional embodiment, the at least one communication comprises a string in Extensible Markup Language (XML).

In still another additional embodiment, the method further comprises the associated service performing at least one of the following services: content playback, cloud transport, entertainment store transport, launching 3^{rd} party applications, updating of applications on the user device, loading of applications on the user device, providing listings data of content, tuner functions, recorder functions, Digital Living Network Alliance (DLNA) compatible functionality, and Universal. Plug and Play (UPnP) functionality.

### BRIEF DESCRIPTION OF THE DRAWINGS

FIG. 1 is a system diagram of user devices running a common application platform with a shared services container and configured to communicate with a content server, application server and update server via the Internet in accordance with an embodiment of the invention.

FIG. 2 is a software stack illustrating a user device including a common application platform running a non-natively implemented application in a virtual. machine and a shared services container with services that can be shared by applications executing on the user device in accordance with an embodiment of the invention.

FIG. 3 is a software stack of a services container including a handler layer sitting on top of a service layer that sits on top of a porting layer in accordance with an embodiment of the invention.

FIG. 4 is a conceptual illustration of a handler using a handler registry to handle communication from an application to a particular service in accordance with an embodiment of the invention.

FIG. 5 is a conceptual illustration of a number of services in the services container in accordance with an embodiment of the invention.

### DETAILED DISCLOSURE OF THE INVENTION

Turning now to the drawings, a common application platform that includes a set of shared services that can be utilized by applications executing on top the application platform in accordance with embodiments of the invention are illustrated. In many embodiments, the application platform can be implemented on a variety of user devices and can support natively implemented applications or applications that execute within a virtual machine. Applications running on the application platform can utilize any of the natively implemented services contained within a services container that is part of the application platform. Due to the fact that the services are natively implemented, they can be significantly more efficient than code executing within a virtual machine. Therefore, resource intensive tasks such as media decoding can be performed much more efficiently using a service as opposed to attempting to perform the same function using code executing within a virtual machine. Also, code is now executable which otherwise would not run properly in a single threaded VM environment, such as Flash. By way of example, a streaming media application can be loaded onto a user device that executes within a virtual machine to render a user interface. When the user requests playback of media, the streaming media application can utilize a media playback service within the services container to handle the streaming and playback of media from a remote server over the Internet. In this way, the user device can safely load applications within the security sandbox of a virtual. machine implemented as part of the application platform and yet avoid the performance constraints imposed by executing code within the virtual machine. The functions that can be performed by services within a services container can be any of a variety of functions, including but not limited to content playback, launching 3^{rd} party applications, updating or loading of applications on the user device, providing listings data of content, tuner and/or recorder functions, Digital Living Network Alliance (DLNA) compatible functionality or Universal Plug and Play (UPnP) functionality.

In various embodiments, applications interface with the services container using sockets. Examples of sockets used in several embodiments of the invention include but are not limited to Flash/ActionScript XML Sockets. Although, in many embodiments, the services are implemented using a web services architecture, the user devices are typically resource constrained and do not fully implement the functionality typically associated with a web server. In numerous embodiments, a handler is provided to manage communications between applications and the services in the services container. The handler intercepts communications from an application, determines the type of service request in the communication, determines the service that corresponds to the service request and forwards the communication to the appropriate service.

In several embodiments, application platforms built in accordance with embodiments of the invention allow third party applications developed using common web technologies (e.g. Flash, HTML5, JavaScript) to execute within the application platform. VMs, including but not limited to web browsers with browser rendering engines, and Flash VMs can run these third party applications on the application platform in the manner described above. Third party applications are limited to the security sandboxes of the virtual machines supported by the application platform, but can leverage the services provided by the application platform. Limitations of virtual machine implementations on CE devices are avoided by offloading processor intensive operations to services that can be more efficient, because they are natively implemented. Also, utilization of sockets allows for highly efficient asynchronous, full duplex communication. Efficiency can be further increased as CE device manufacturers can port the entire application platform by simply porting a thin porting layer in the services container to port the entire application platform.

In many embodiments of the invention, developers can develop one application for multiple different types of user device and the applications can utilize efficient services within the application platform to achieve high levels of performance. Thereby, efficiency is improved and the cost of supporting third party applications is significantly reduced for CE manufacturers by providing an application platform that can be readily ported to different classes of device.

System Architecture

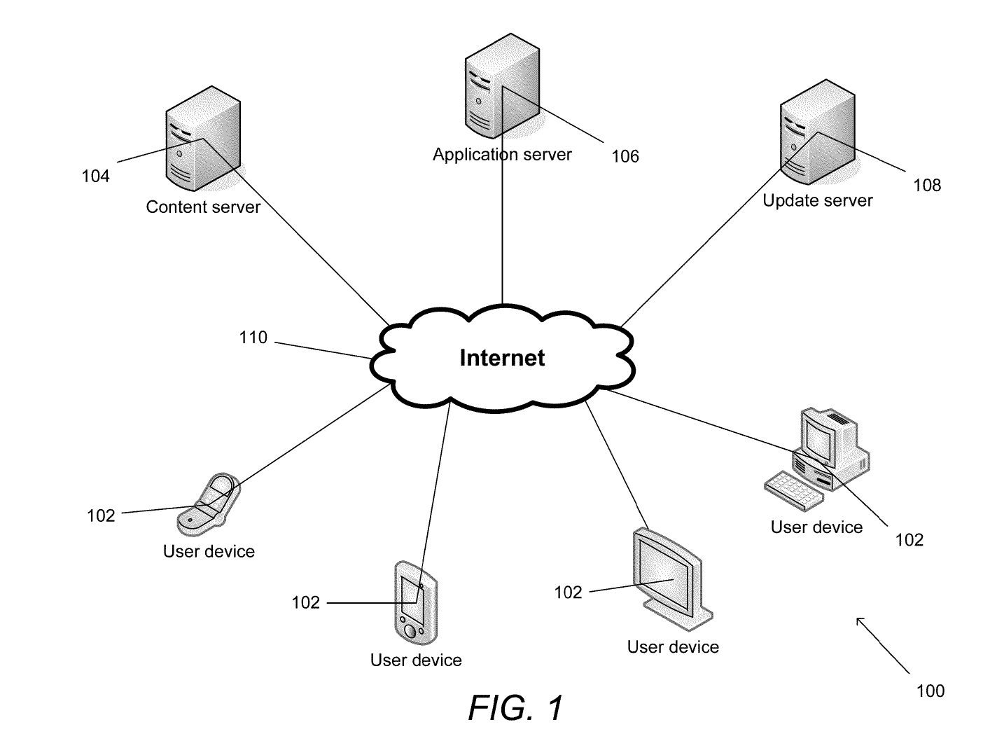

A system including user devices running common application platforms in accordance with an embodiment of the invention is illustrated in FIG. 1. The system 100 includes a number of different types of user device 102 that each runs a common application platform. In many embodiments, each of the various user devices 102 include applications running on common application platforms utilizing natively implemented services, and the user devices are connected to a content server 104, application server 106 and update server 108 over the Internet. In several. embodiments, the common application platform enables non-natively implemented applications to execute on each of the user devices. The user devices 102 communicate with a content server 104, application server 106 and update server 108 over a network such as the Internet 110. In several. embodiments, the content server 104 is a server that can deliver content to the user devices 102. In many embodiments, the content can be downloaded and/or streamed by the user devices 102. In a number of embodiments, application servers 106 store applications that can be downloaded and installed on user devices 102. Update servers 108 can provide updates to applications installed on a user device 102 and/or to the firmware of the user device 102.

In various embodiments, the natively implemented services in the services container can be utilized by applications running on the application platform and applications natively implemented for the user device. The inclusion of a natively implemented services container shared among applications is efficient as natively implemented services are faster than both services called from a remote server over the Internet and services rendered by an application running in a VM. By way of example, an application running with an application platform on a user device 102 can utilize a natively implemented media playback service from the services container and stream content from the remote content server 104 over the Internet.

Common application platforms with services containers that can be ported to user devices in accordance with embodiments of the invention are discussed further below.

User Device Software Stack

User devices in accordance with embodiments of the invention are configured with an application platform that runs on top of a device platform. The application platform includes a virtual machine that can run non-natively implemented applications and a services container. The virtual machine enables safe operation of non-natively implemented applications in the security sandbox of the virtual machine. The services container enables fast and secure natively implemented services for use by both native and non-natively implemented applications and includes a thin porting layer allowing for fast porting of the application platform among different devices.

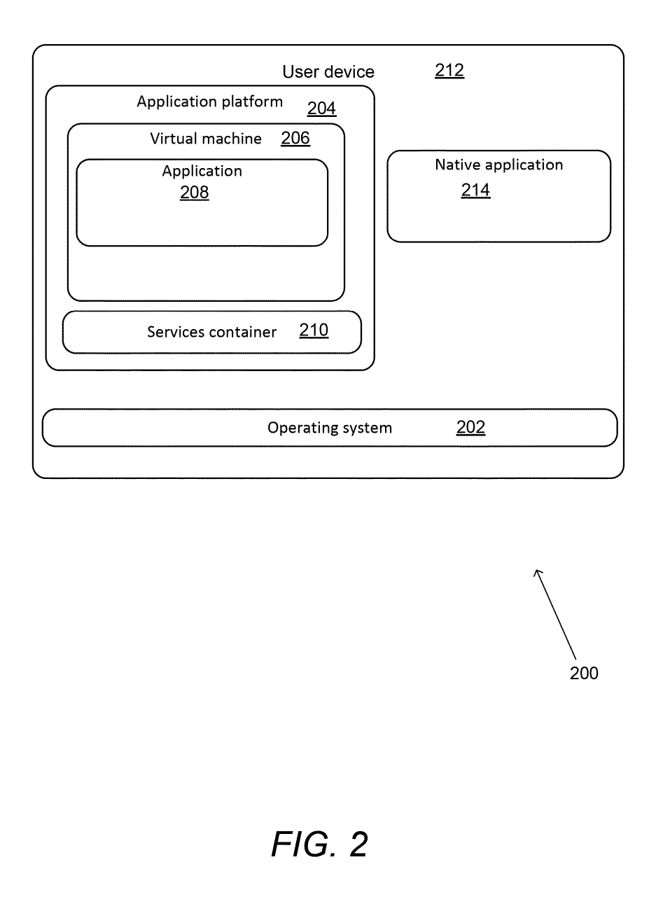

A software stack of a common application platform and device platform in accordance with an embodiment of the invention is illustrated in FIG. 2. The software stack 200 includes a device platform (i.e. the device's operating system 202) and a common application platform 204. The common application platform 204 includes one or more virtual machines 206 capable of running non-natively implemented applications 208 and a services container 210 accessible by applications executing on top of the application platform. In many embodiments, user devices 212 can also include natively implemented applications 214 that can utilize services included in the services container 210.

In many embodiments, a user device 212 includes a device platform that includes an operating system 202. An application platform 204 includes a virtual. machine 206 able to run non-natively implemented applications 208 and a services container 210. The common application platform 204 can be implemented within the firmware of the user device 212. The virtual machine 206 features a security sandbox that enables secure execution of non-natively implemented applications 208 including applications downloaded via the Internet on the user device. In many embodiments, the services container 210 includes a porting layer to quickly and effectively port the application platform to the device platform, enabling the application platform to be usable in most user devices. In several embodiments, the services container is written in C++ code requiring only a cross-compile with the device's toolchain in order to be usable in most user devices. The services container 210 also includes natively implemented services that applications can use, whether a non-natively implemented application 208 running in the virtual machine or a natively implemented application 214 running in the user device 212. The natively implemented services are typically faster, more efficient and more secure than a non-natively implemented application attempting to perform the same function or handing off the functionality to a remote web service.

In several embodiments, applications communicate with the services container using sockets. A socket is opened when the services container is initialized by an application or is loaded in the memory of the device. The socket remains open so long as the services container remains active, or so long as the services container remains loaded within the dynamic memory of the device.

Although a specific software stack is illustrated above in FIG. 2, any of a variety of software stacks can be utilized to implement a common application platform including at least one virtual machine and a services container in accordance with embodiments of the invention. Services containers in accordance with embodiments of the invention are discussed further below.

Services Container

Common application platforms in accordance with embodiments of the invention are typically designed with a services container to provide a service layer including a set of natively implemented services that can be shared by a number of different applications and to enable rapid porting between different types of user device. Accordingly, services containers in accordance with many embodiments of the invention are separated into a software stack with communication between the services of the service layer and applications handled by a handler in the handler layer. When implemented in this manner, applications can utilize and share any of the natively implemented services in the services container. Additionally, a developer seeking to port the common application platform to a new device can simply port a porting layer and the remainder of the source code of the application platform can remain largely untouched.

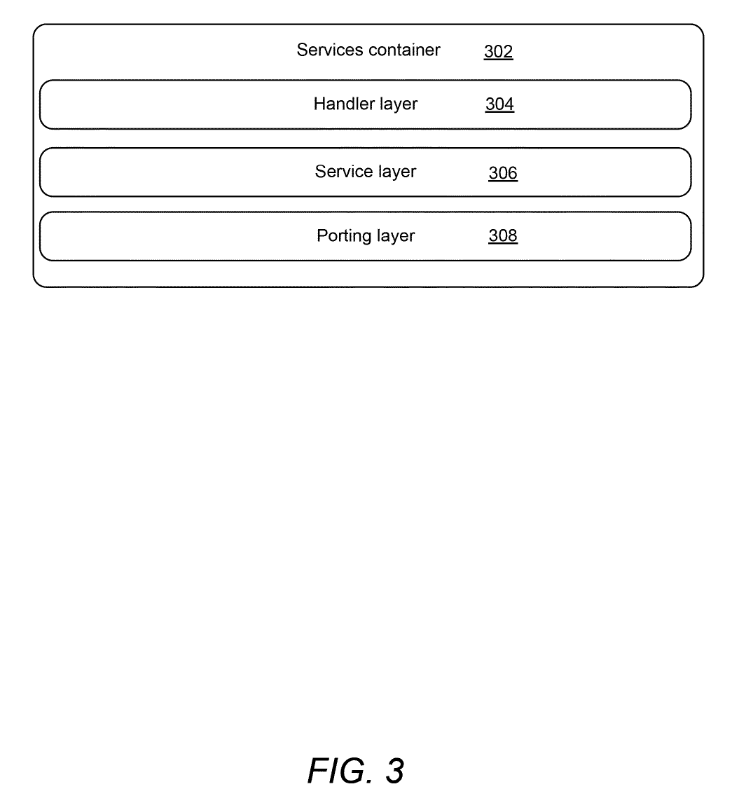

A services container implemented using a handler layer for handling communication via sockets between an application and services in accordance with an embodiment of the invention is illustrated in FIG. 3. In the illustrated embodiment, the services container 302 includes a handler layer 304 that sits on top of a service layer 306 that sits on top of a porting layer 308. In certain embodiments, an application can launch the services container 302, allowing for applications to use services in the service layer 306 within the services container 302. The initializing process can involve loading the executable code for the service out of the firmware of the device and into dynamic memory. The handler layer 304 handles communication between the application and services in the services layer 306. Usage of a handler layer 304 rather than an embedded web server allows the services container to implement a web services architecture between the applications and service layer without requiring the resources that would be consumed by, for example, a fully implemented embedded web server.

The service layer 306 can include one or more services that can be utilized by applications, natively or non-natively implemented. In various embodiments, services in the service layer 306 can be updated along with firmware updates to the device to enable device manufacturers or managers a chance to avoid the inclusion of unwanted services during an update. However, in numerous embodiments the services layer do not need to be updated concurrently with firmware updates. The service layer 306 is natively implemented on the user device, making the use of services more efficient than implementing similar functionality using code that executes within a virtual machine or services called remotely over the Internet via a web server. The services container 302 also includes a porting layer 308 that abstracts aspects of the services container including (but not limited to) the services, the handler, and any virtual. machines from the underlying operating system and allowing for fast and effective porting of the application platform among many devices and device platforms. In some embodiments, each service may contain a porting layer. In many embodiments, the services container will only require a cross-compile. In various embodiments, a service layer does not include a porting layer. The services container itself can sit on top of a porting layer. In several embodiments, the porting layer 308 allows for the application platform to be utilized on many different device platforms by simply modifying the source code of the porting layer 308 according to the requirements of the device platform of a specific device. In this way, the process of porting the common application platform to a new device can be simplified by generally limiting modifications to the ported code to the code within the porting layer 308.

Although a specific services container in illustrated above in FIG. 3, any of a variety of implementations can be utilized to implement a services container including shared services that communicate with applications via sockets in accordance with embodiments of the invention. Processes in accordance with embodiments of the invention related to how services are utilized are discussed further below.

Handler

A handler layer in the services container handles service requests from applications executing on top of the application platform. In many embodiments, the handler receives service requests via a socket and determines the specific service within the services container that is appropriate to handle the requested service. At which point, the handler can forward the service request to the appropriate service.

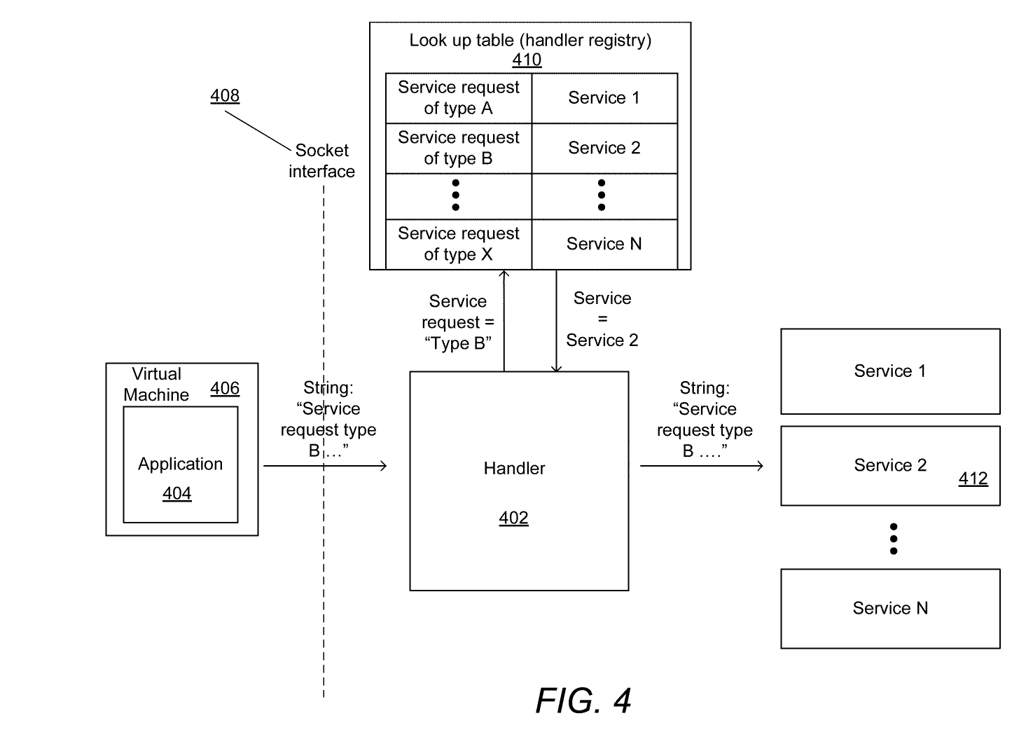

A handler handling communication between an application running within a virtual machine and services in a services container according to an embodiment of the invention is illustrated in FIG. 4. The handler 402 resides in the services container and receives service requests from one or more applications 404 executing within the virtual. machine 406 via a socket interface 408. In several embodiments, the handler 402 receives service requests from one or more natively implemented applications via the socket interface 408. In many embodiments, the communications are a string, such as an XML string, passed from the application to the handler 402 via the socket interface 408. The handler 402 can parse the string and determine the service request type from the string. The handler 402 uses the type of service request in the string to look up the service associated with the service request in a handler registry 410. When the service associated with the service request is located within the handler registry, the string is passed by the handler to the appropriate service 412.

In the illustrated embodiment, a string passed from the application 404 to the handler 402 in the services container via the socket interface could include a service request for commencing playback of content. The service request for commencing content playback would be looked up in a look up table 410, which would associate the service of commencing content playback to a content playback service. The handler 402, now knowing that the service request corresponds to the content playback service, passes the string to the content playback service 412. The content playback service can read the string with the service request and can commence content playback.

Any service 412 within the services container can be associated with a certain service request type. A service request type is a generic term for a particular type of service request, such as where a playback service request type can be associated with a playback service 412 including commencing content playback, pausing content playback, or resuming content playback. Although, services are not limited to playback services and can provide any service capable of being executed on a specific user device.

Communication can be sent from services in a service container to a non-natively implemented application running in a virtual machine or a natively implemented application. In many embodiments, there is an application connected to the services container through an open socket. A response from a service to a service request from an application can be written back to the application through the open socket. The response can include an identifier referencing the communication that the response is responding to. Unsolicited communications, which are communications from a service to an application not sent in response to a service request, are sent to the application through the open socket. Unsolicited communications can include an identifier that an application can recognize to process the communication.

Although a specific handler is illustrated above in FIG. 4, any of a variety of implementations can be utilized to implement a handler layer including multiple handlers that can handle communications between numerous applications running in a virtual machine and the services in the services container. The types of services that can be utilized by applications running on top of the application platform in accordance with embodiments of the invention are discussed further below.

Different Service Types

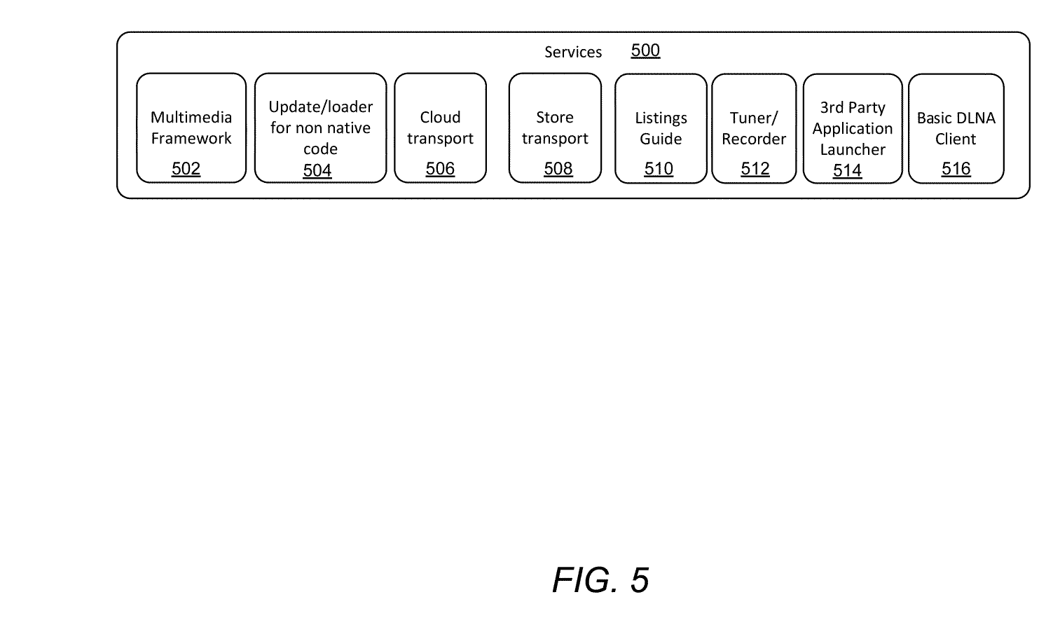

Services in accordance with many embodiments of the invention are natively implemented and shared as part of a services container by applications, including applications running in a virtual machine on top of an application platform. As noted above, the types of services that can be implemented within the services container of a common application platform are typically only limited by the capabilities of the device on which the common application is implemented. Various services that can be utilized by applications in accordance with embodiments of the invention are illustrated in FIG. 5. In the illustrated embodiment, the services 500 within the service container include a multimedia framework service 502 that enables playback of content designed for playback on a specific media player by determining the media player appropriate for the playback and passing instructions for media playback to the appropriate player. The services container also includes an update or loader service 504 that can be used for updating or loading non-natively implemented code as necessary, and a cloud transport service 506 that enables an application to communicate with a remote server for services rendered over a network. Applications can use the Cloud transport as an HTTP or HTTPS client that handles security for communication with remote servers. An entertainment store transport 508 service within the services container may utilize a different transport than the generic Cloud transport service 506 such as transport for an entertainment store directly in the Cloud. A listings guide service 510 can be included in the services container and is a database formed from listings data taken from a video broadcast stream and/or from Internet Data Download (IDD). The services container can also include a tuner/recorder service 512, which allows for tuning to content and recording of content such as Digital. Video Recording (DVR). A 3rd party application launcher service 514 enables an application to launch 3rd party applications for features of a 3rd party content provider. The services container can also include a basic DLNA Client API service 516, which enables using universal plug and play (UPnP). A generic client API can be utilized for UPnP service. Typically, an UPnP client includes browse/search functionality and a digital media controller to determine the proper UPnP to use.

In several embodiments of the invention, the services container includes an update/loader service 504. The update/loader manages the update or loading of the application platform. In many embodiments, the update/loader updates the handler registry once each time the services container is loaded. Also, in certain embodiments, the update/loader can update the services only along with updates to the user device firmware. In this way, updating and loading of modules only requires that the handler registry in the services container need be updated rather than requiring replacement of the entire services container at each update. Although a specific set of services discussed above with respect to FIG. 5, any of a variety of services can be incorporated into a services container in accordance with embodiments of the invention that can be utilized as appropriate by applications that pass requests to the services via a handler within the services container.

While the above description contains many specific embodiments of the invention, these should not be construed as limitations on the scope of the invention, but rather as an example of one embodiment thereof.

1. A user device, comprising:
a processor configured by an operating system;
wherein the processor is further configured by an application platform comprising:
a natively implemented virtual machine configured to execute non-natively implemented applications;
a services container, comprising;
at least one natively implemented service configured for utilization by an application executing within the virtual machine, wherein the at least one natively implemented service is a shared service that can be utilized by a plurality of different applications; and
at least one handler configured to handle communication via at least one socket between an application executing within the virtual machine and the at least one natively implemented service in the services container.

2. The user device of claim 1, wherein the handler is configured to handle communication by passing the communication from an application to a service associated with a service request type specified in the communication.

3. The user device of claim 2, wherein:
the handler is configured to determine the service associated with a service request using a handler registry; and
the handler registry comprises a look up table associating service request types with services.

4. The user device of claim 3, wherein the handler registry is updated when the services container is loaded into dynamic memory in the user device.

5. The user device of claim 1, wherein the processor is part of the firmware of the user device and the firmware also comprises read only memory in which the operating system and the application platform are stored.

6. The user device of claim 1, wherein the application platform further comprises a porting layer.

7. The user device of claim 1, wherein:
the device further includes a natively implemented application to further configure the processor; and
the natively implemented application is configured to communicate with at least one natively implemented service via at least one socket.

8. The user device of claim 1, wherein the virtual. machine is a web browser with a browser rendering engine.

9. The user device of claim 8, wherein the non-natively implemented application is a web application.

10. The user device of claim 1, wherein the communication is a string in Extensible Markup Language (XML).

11. The user device of claim 1, wherein:
the at least one natively implemented service performs a service that is at least one of:
content playback;
cloud transport;
entertainment store transport;
3^{rd} party application launch;
application updating;
application loading;
content data listings;
tuner functions;
recorder functions;
Digital Living Network Alliance (DLNA) compatible functionality; and
Universal Plug and Play (UPnP) functionality.

12. A method of executing an application that utilizes at least one service in a services container, where the services container is part of a common application platform implemented on a user device, the method comprising:
sending at least one communication from a non-natively implemented application executing within a virtual machine to a service within a service container via a socket interface, where the virtual machine is natively implemented and forms part of a common application platform implemented on a user device;
identifying a service request type within the at least one communication using a handler in the services container;
determining a service associated with the service request type using the handler; and
passing the at least one communication to the associated service in the services container using the handler.

13. The method of claim 12, wherein determining the associated service comprises querying the service request type in a look up table on the user device that associates service request types with services in the services container.

14. The method of claim 12, wherein the natively implemented virtual machine is part of a web browser rendering engine.

15. The method of claim 14, wherein the non-natively implemented application is a web application.

16. The method of claim 12, wherein the at least one communication comprises a string in Extensible Markup Language (XML).

17. The method of claim 12, wherein the method further comprises the associated service performing at least one of the following services:
content playback;
cloud transport;
entertainment store transport;
launching 3^{rd} party applications;
updating of applications on the user device;
loading of applications on the user device;
providing listings data of content;
tuner functions;
recorder functions;
Digital Living Network Alliance (DLNA) compatible functionality; and
Universal Plug and Play (UPnP) functionality.
